(19) United States
(12) Patent Application Publication
(10) Pub. No.: US 2005/0231505 A1
(43) Pub. Date: Oct. 20, 2005

(54) Method for creating artifact free three-dimensional images converted from two-dimensional images

(76) Inventors: Michael C. Kaye, Agoura Hills, CA (US); Charles J. L. Best, Los Angeles, CA (US)

Correspondence Address: HENRICKS SLAVIN AND HOLMES LLP;SUITE 200, 840 APOLLO STREET, EL SEGUNDO, CA, 90245, US

(21) Appl. No.: 10/882,524

(22) Filed: Jun. 30, 2004

Related U.S. Application Data
(63) Continuation-in-part of application No. 10/792,368, filed on Mar. 2, 2004.
Application No. 10/792,368 is a continuation-in-part of application No. 10/674,688, filed on Sep. 30, 2003.
Application No. 10/674,688 is a continuation-in-part of application No. 10/316,672, filed on Dec. 10, 2002.
Application No. 10/316,672 is a continuation-in-part of application No. 10/147,380, filed on May 15, 2002.
Application No. 10/147,380 is a continuation-in-part of application No. 10/029,625, filed on Dec. 19, 2001, now Pat. No. 6,515,659.
Application No. 10/029,625 is a continuation-in-part of application No. 09/819,420, filed on Mar. 26, 2001, now Pat. No. 6,686,926.
Application No. 09/819,420 is a continuation-in-part of application No. 09/085,746, filed on May 27, 1998, now Pat. No. 6,208,348.

(51) Int. Cl. G06T 15/40; G06T 15/00

(52) U.S. Cl. 345/421; 345/419

(57) ABSTRACT

A method for converting two-dimensional images into three-dimensional images includes tracking an image reconstruction of hidden surface areas to be consistent with image areas adjacent to the hidden surface areas over a sequence of frames making up a three-dimensional motion picture.

### CROSS-REFERENCE TO RELATED APPLICATIONS

This application is a continuation-in-part of U.S. patent application Ser. No. 10/792,368 entitled “Method For Creating And Presenting An Accurate Reproduction Of Three-Dimensional Images Converted From Two-Dimensional Images” filed on Mar. 2, 2004, which is a continuation-in-part of U.S. patent application Ser. No. 10/674,688 entitled “Method For Minimizing Visual Artifacts Converting Two-Dimensional Motion Pictures Into Three-Dimensional Motion Pictures” filed on Sep. 30, 2003, which is a continuation-in-part of U.S. patent application Ser. No. 10/316,672 entitled “Method Of Hidden Surface Reconstruction For Creating Accurate Three-Dimensional Images Converted From Two-Dimensional Images” filed on Dec. 10, 2002, which is a continuation-in-part of U.S. patent application Ser. No. 10/147,380 entitled “Method For Conforming Objects To A Common Depth Perspective For Converting Two-Dimensional Images Into Three-Dimensional Images” filed on May 15, 2002, which is a continuation-in-part of U.S. patent application Ser. No. 10/029,625 entitled “Method And System For Creating Realistic Smooth Three-Dimensional Depth Contours From Two-Dimensional Images” filed on Dec. 19, 2001, now U.S. Pat. No. 6,515,659, which is a continuation-in-part of U.S. patent application Ser. No. 09/819,420 entitled “Image Processing System And Method For Converting Two-Dimensional Images. Into Three-Dimensional Images” filed on Mar. 26, 2001, now U.S. Pat. No. 6,686,926, which is a continuation-in-part of U.S. patent application Ser. No. 09/085,746 entitled “System And Method For Converting Two-Dimensional Images Into Three-Dimensional Images” filed on May 27, 1998, now U.S. Pat. No. 6,208,348, all of which are incorporated herein by reference in their entirety.

### BACKGROUND ART

In the process of converting a two-dimensional (2D) image into a three-dimensional (3D) image, at least two perspective angle images are needed independent of whatever conversion or rendering process is used. In one example of a process for converting two-dimensional images into three-dimensional images, the original image is established as the left view, or left perspective angle image, providing one view of a three-dimensional pair of images. In this example, the corresponding right perspective angle image is an image that is processed from the original image to effectively recreate what the right perspective view would look like with the original image serving as the left perspective frame.

In the process of creating a 3D perspective image out of a 2D image, as in the above example, objects or portions of objects within the image are repositioned along the horizontal, or X axis. By way of example, an object within an image can be “defined” by drawing around or outlining an area of pixels within the image. Once such an object has been defined, appropriate depth can be “assigned” to that object in the resulting 3D image by horizontally shifting the object in the alternate perspective view. To this end, depth placement algorithms or the like can be assigned to objects for the purpose of placing the objects at their appropriate depth locations.

When creating the alternate perspective view, the repositioning of an object within the image can result in areas within the image for which pixel data is undetermined or incorrect. For example, by conforming placements and surfaces of objects in a left image to a corresponding right perspective angle viewpoint, the horizontal shifting of objects often results in separation gaps of missing image information that, if not corrected, can cause noticeable visual artifacts such as flickering or shuttering pixels at object edges as objects move from frame to frame.

In view of the foregoing, it would be desirable to be able to recreate a high quality, realistic three-dimensional image from a two-dimensional image in such a manner that conversion artifacts are eliminated or significantly minimized.

### BRIEF DESCRIPTION OF THE DRAWINGS

FIG. 1A illustrates a foreground object and a background object with the foreground object being shifted to the left and an incorrect method for pixel repeat having been employed;

FIG. 1B illustrates the foreground and background objects of FIG. 1A with a correct method of pixels repeat having been employed minimizing artifacts;

FIG. 1C illustrates a foreground object and a background object with the foreground object being shifted to the right and an incorrect method for pixel repeat having been employed;

FIG. 1D illustrates the foreground and background objects of FIG. 1C with a correct method of pixels repeat having been employed minimizing artifacts;

FIG. 2A illustrates an image with a foreground object, the person, shifted to the left, or into the foreground, leaving a hidden surface area exposed;

FIG. 2B illustrates a subsequent frame of the image of FIG. 2A, revealing available pixels that were previously hidden by the foreground object that has moved to a different position in the subsequent frame;

FIG. 3A illustrates an arbitrary object having shifted its position leaving a gap exposing a hidden surface area;

FIG. 3B illustrates the object of FIG. 3A with a background pattern;

FIG. 3C illustrates an example of a bad hidden surface reconstruction with noticeable artifacts resulting from pixel repeating;

FIG. 3D illustrates an example of a good hidden surface reconstruction;

FIG. 4A illustrates an example of a method for pixel repeating towards a center of a hidden surface area;

FIG. 4B illustrates an example of a method for automatically dividing a hidden surface area and placing source selection areas adjacent to the hidden surface area into each portion of the divided hidden surface area;

FIG. 4C illustrates an example of how the source selection areas of FIG. 4B can be independently altered to find the best image content for the hidden surface area;

FIG. 4D illustrates an example method for rapidly reconstructing an entire hidden surface area from an adjacent reconstruction source area;

FIG. 4E an example of how the reconstruction source area of FIG. 4D can be altered to find the best image content for the hidden surface area;

FIG. 5A illustrates an example of an object having shifted in position;

FIG. 5B illustrates an example method for indicating a selection of an area of hidden surface area to be reconstructed;

FIG. 5C illustrates an example default position of reconstruction source area automatically produced directly adjacent to the area of hidden surface area selected in FIG. 5B;

FIG. 5D illustrates an example of a user grabbing and moving the reconstruction source area of FIG. 5C;

FIG. 5E illustrates another example of a user moving the reconstruction source area of FIG. 5C, to a different location to find better image content for the hidden surface area;

FIG. 5F illustrates an example of a good image reconstruction with a consistent pattern where a user repositioned the reconstruction source area to a better candidate region;

FIG. 5G illustrates an example of a bad image reconstruction with an inconsistent pattern resulting in image artifacts where a user repositioned the reconstruction source area to a poor candidate region;

FIGS. 6A and 6B illustrate an example object and how a user tool can be used to horizontally decrease the size of a reconstruction source area from its right side and left side, respectively;

FIG. 6C illustrates how a user tool can be used to incrementally shift the position of the reconstruction source area;

FIG. 6D illustrates how an example method for reconstructing hidden surface areas automatically re-scales the contents of a reconstruction source area into a hidden surface area;

FIG. 7A illustrates how an example method for reconstructing hidden surface areas allows a user to select a mode that causes a reconstruction source area to appear that extends from the hidden surface area the same distance across the hidden surface area from the boundary adjoining the object and the hidden surface area to the outside edge of the hidden surface area;

FIG. 7B illustrates how an example method for reconstructing hidden surface areas allows a user to select a mode that allows the user to indicate start and end points along a boundary of a hidden surface area and to grab and pull the boundary to form a reconstruction source area;

FIG. 8 illustrates an example of hidden surface reconstruction using source image content from other frames;

FIG. 9 illustrates an example of using a reconstruction work frame;

FIG. 10 illustrates an example of how image objects may wander from frame to frame;

FIGS. 11A-11D illustrate an example of a method for detecting the furthest most point of an object's movement;

FIG. 12A illustrates an example of a foreground object having shifted in position in relation to a background object, leaving a hidden surface area, and a source area to be used in reconstructing the hidden surface area;

FIG. 12B illustrates the background object of FIG. 12A having shifted, and how an example method for hidden surface reconstruction results in the source area tracking the change;

FIG. 12C illustrates the result of the example method of FIG. 12B;

FIG. 13A illustrates an example method for hidden surface reconstruction that causes a source area in a background object to maintain its position relative to a hidden surface area when the background object changes in size;

FIG. 13B illustrates an example method for hidden surface reconstruction that causes a source area in a background object to maintain its position relative to a hidden surface area when the background object changes in shape;

FIG. 13C illustrates an example method for hidden surface reconstruction that causes a source area in a background object to maintain its position relative to a hidden surface area when the background object changes in position;

FIG. 14A illustrates how a source data region can be larger than a hidden surface region to be reconstructed;

FIGS. 14B and 14C illustrate how an example method for hidden surface reconstruction causes a source data region to track changes in the background object;

FIG. 15A illustrates an example foreground object against a bush or tree branches background object;

FIG. 15B illustrates the example of FIG. 15A with the foreground object having moved revealing a hidden surface area;

FIG. 15C illustrates the effects of pixel repeating with the example of FIG. 15B;

FIG. 15D illustrates the foreground object of FIG. 15A first shifting its position;

FIG. 15E illustrates an example method for hidden surface reconstruction that mirrors, or flips, image content adjacent a hidden surface area to cover the hidden surface area;

FIG. 15F illustrates the end result of the mirroring of FIG. 15E;

FIG. 16A illustrates an example of how a source selection area to be filled in to a hidden surface area can be decreased in size;

FIG. 16B illustrates an example of how a source selection area to be filled in to a hidden surface area can be increased in size;

FIG. 16C illustrates an example of how a source selection area to be filled in to a hidden surface area can be rotated;

FIG. 17A illustrates an example foreground object against a chain link fence background object;

FIG. 17B illustrates the example of FIG. 17A with the foreground object having moved causing a hidden surface area to be pixel repeated;

FIG. 17C illustrates the effects of pixel repeating with the example of FIG. 17B;

FIG. 17D illustrates an example method for hidden surface reconstruction that mirrors, or flips, image content in a source area adjacent the hidden surface area of FIG. 17B to cover the hidden surface area;

FIG. 17E illustrates how the source area can be repositioned to find the best source content to mirror into the hidden surface area;

FIG. 17F illustrates the end result of the mirroring and repositioning of FIG. 17E, when a good match of source pixels is selected to fill the hidden surface area; and

FIG. 18 illustrates an example system and workstation for implementing image processing techniques according to the present invention.

### DISCLOSURE OF INVENTION

The present invention relates to methods for correcting areas of missing image information in order to create a realistic high quality three-dimensional image from a two-dimensional image. The methods described herein are applicable to both full-length motion picture images, as well as individual three-dimensional still images.

When the angle, or perspective of an image changes, as in the case of an image being created to be part of a three-dimensional image, image information around foreground to background object edges in the newly created image becomes revealed by virtue of that different perspective angle of view. These areas are referred to as “Hidden Surface Areas”.

In the present description, the term “Hidden Surface Areas” are those areas around objects that would otherwise be hidden by virtue of the other perspective angle of view, but become revealed by creating the new perspective angle of view.

Sometimes these Hidden Surface Areas are also referred to as “Occluded Areas”, or “Occluded Image Areas”. Nevertheless, these are the same areas of missing information at edges of foreground to background objects that happen to be created, or come into view by virtue of the other angle of view. In a stereoscopic pair of images, the image information at these Hidden Surface Areas occurs in one of the two images and not the other.

If an image is photographed in 3D, the information at these edges would contain image information. In the case of images being converted from 2D into 3D (a reconstruction of depth information), a newly created perspective image does not contain the information at these Hidden Surface Areas. Without image information at these Hidden Surface Areas, visual artifacts become noticeable. In order to provide for clean artifact free 3D reconstruction or conversion, the information in these Hidden Surface Areas must be addressed.

The correction or reconstruction of this missing information in the Hidden Surface, or Occluded Image, areas is part of the depth restoration (2D to 3D) process and is referred to as “Hidden Surface Reconstruction”.

Even though the Hidden Surface Areas are a main part of depth perception, these areas also produce a different visual sensation if the focus of attention happens to be directed at those areas. As this information is only seen by one eye, it stimulates this different sensation. A brief discussion of the nature of visual sensations and how the human brain interprets what is seen is presented below.

Visual perception involves three fundamental experienced sensations. One experience is the visual sensation that is experienced when both eyes perceive exactly the same image, such as a flat surface, like a picture or a movie screen, for instance. A similar sensation would be what is experienced with only one eye and the other shut. A second, yet different sensation is what is experienced when each eye simultaneously focuses on objects from their respective perspective angles. This visual sensation is what is experienced as normal 3D vision. As part of 3D vision there is yet a third visual sensation that is experiences, namely, when only one eye sees image information that differs from or is not perceived by the other eye. When seeing this disparity, the visual sensation feels different than the experience of both eyes seeing the same image information. It is in fact this disparity between the left and right eyes that not only help a person focus and distinguish between foreground and background information, but also and more importantly signals visual attention.

It is the consistency and uniformity of image content along the edges of objects that allows visual processing to be accepted as a legitimate coherent 3D image. Conversely, if the information at these Hidden Surface Areas starts to become out of context with its adjacent surroundings, visual interpretation will tend to draw attention to these areas and perceive them as distracting artifacts. It is when these differences become too great and inconsistent with the natural flow of image information in particular areas of an image that the brain stimulates human visual senses to consciously perceive such image artifacts as distracting and unreal. Hidden Surface Areas are therefore an important factor that needs to be addressed when converting two-dimensional images into three-dimensional images.

Image Artifact Correction Tools:

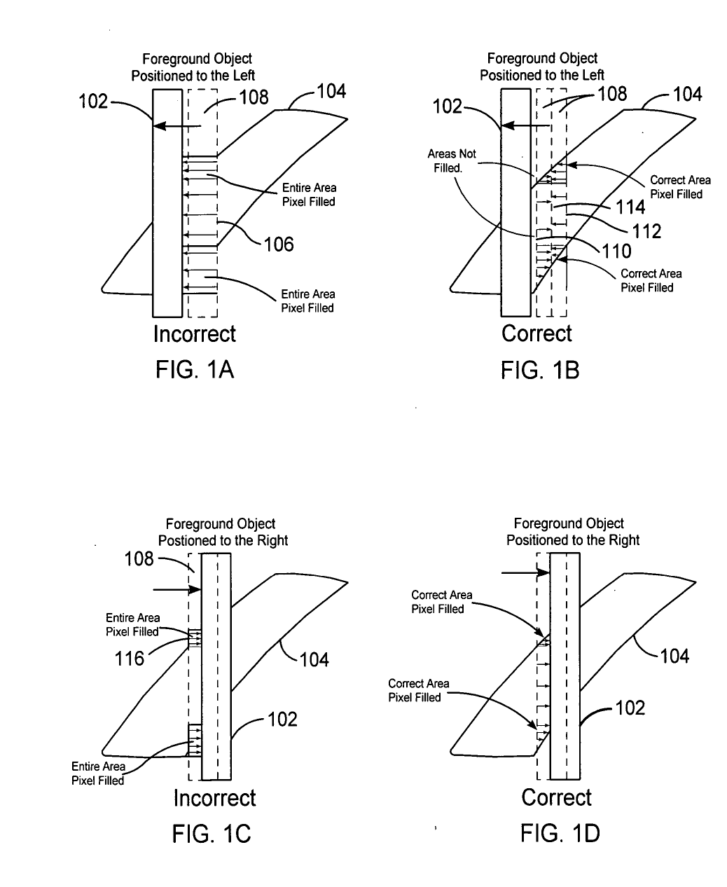

Various embodiments of the present invention involve minimizing or lessening the pixel repeating of artifacts during the process of converting two-dimensional images into three-dimensional images. FIG. 1A shows a foreground object 102 and a background object 104 with the foreground object 102 being shifted to the left in order to create an alternate perspective image. In this example, which illustrates an incorrect method for pixel repeating, background pixels are repeated across from the entire right edge 106 of the hidden surface area 108 (shown in dashed lines). FIG. 1B illustrates an example method of pixel repeating wherein only background pixels of the object directly behind the foreground object 102 (in its original position) are repeated from the left edge 110 and the right edge 112 of the hidden surface area 108 to a center 114 (shown with a dashed line) of the hidden surface area 108. In this example, as shown in FIG. 1B, pixels are only repeated within the area of the background object 104. Thus, in this example, a pixel repeating method that minimizes or lessens image artifacts is provided.

FIG. 1C illustrates another example of an incorrect method for pixel repeating. In this example, the foreground object 102 being shifted to the right in order to create an alternate perspective image, and background pixels are repeated across from the entire left edge 116 of the hidden surface area 108. FIG. 1D illustrates another example of pixel repeating wherein only pixels of the background object 104 are repeated.

Image content can be provided to fill gaps in alternate perspective images in ways that are different from the pixel repeating approach described above. Moreover, in some instances during the process of converting two-dimensional images into three-dimensional images, the background information around an object being shifted in position is not suitable for the above pixel repeating approach.

In U.S. patent application Ser. No. 10/316,672 entitled “Method Of Hidden Surface Reconstruction For Creating Accurate Three-Dimensional Images Converted From Two-Dimensional Images”, methods were described for restoring accurate picture information to the Hidden Surface Areas consistent with surrounding areas of image objects, e.g., by allowing the retrieval of accurate image information that may become revealed in other frames over time. In many cases, this is an ideal approach since hidden surface pixels may be accessible in other frames, and the user interface provides for easy access and retrieval of the information in a timely manner. As a typical motion picture feature may contain over a hundred and fifty thousand frames, tools that allow a user to work rapidly are essential in order to process full-length motion pictures into 3D in a time allowable realm.

A significant benefit of various methods for converting two-dimensional images into three-dimensional images according to the present invention is that only a single additional complimentary perspective image needs to be created. The original image is established as one of the original perspectives and therefore remains intact. This is a tremendous advantage to the complete three-dimensional conversion process of correcting the hidden surface areas since only a single image needs to be derived to complete the three-dimensional pair of images. The repair processing of the hidden surface areas only needs to take place in one of the three-dimensional images, not both. If both perspective images had to have their hidden surface areas processed, twice as much work would be required. Thus, in various embodiments, reconstruction of hidden surfaces areas need only take place in one of the perspectives.

Another benefit of various methods for converting two-dimensional images into three-dimensional images according to the present invention is that original pixels are still available even if they are covered up by an object and then uncovered. In an example embodiment, the original image pixels are always maintained or stored.

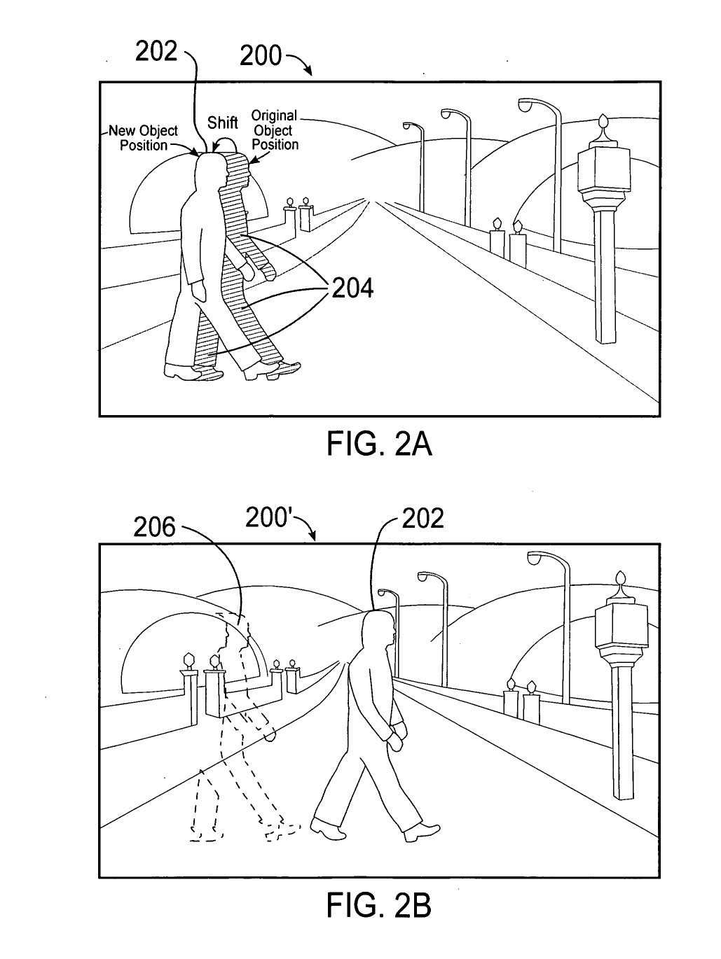

FIG. 2A shows an example image 200 with a foreground object 202, a man crossing a street, shifted to the left to place it into the foreground resulting in hidden surface areas 204 of missing information. As shown in this example, the hidden surface areas 204 are portions of the image 200 to the right of the new position of the object and within the original area in the image occupied by the object. In order for the image 200 to serve as a realistic artifact-free alternate perspective view, hidden surface reconstruction of the hidden surface areas 204 needs to be consistent with the surrounding background so that visual senses will accept it with its surroundings and not notice it as a distracting artifact. The resulting alternate perspective image must accurately represent what that image would look like from perspective angle of view of that image. By way of example, reconstruction of the hidden surface areas 204 can involve taking image information from other areas within the same image 200. Also by way of example, and referring to FIG. 2B, reconstruction of hidden surface areas can involve taking image information from areas within a different image 200′. In this example, the image 200′ is a subsequent frame of the image 200 (FIG. 2A), revealing an area 206 of available background pixels that were previously hidden by the foreground object 202 that has moved to a different position.

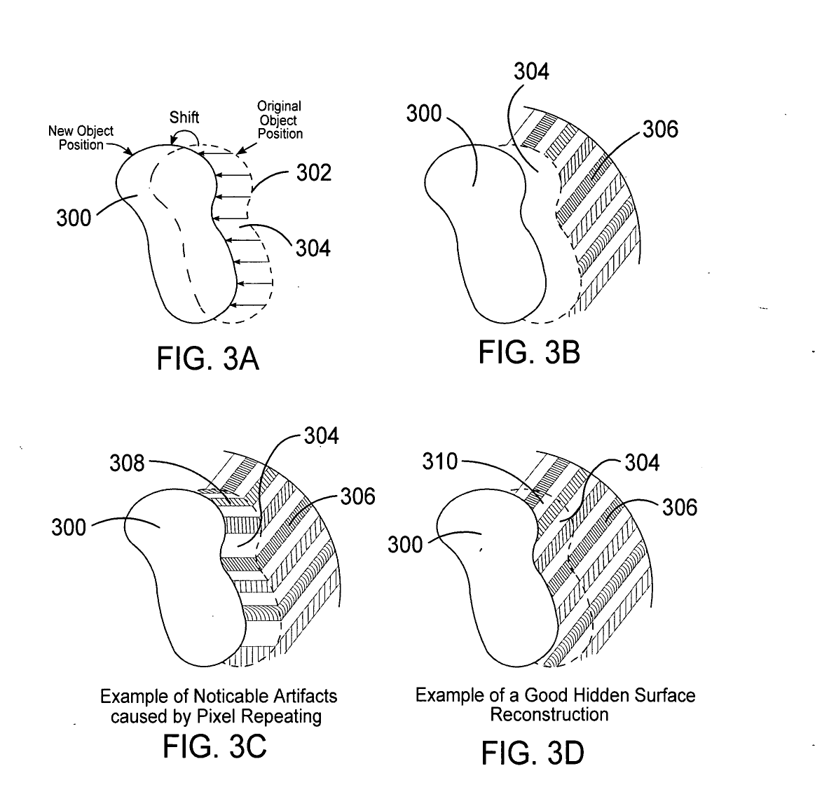

FIG. 3A shows an example of an object that has been placed into the foreground in a newly created alternate perspective frame. By shifting the object into the foreground, the object is shifted to the left resulting in a gap of missing picture information. In this example, FIG. 3A shows an object 300 shifted to the left from its original position 302 (shown in dashed lines) leaving a gap exposing a hidden surface area 304. FIG. 3B illustrates the object 300 and the hidden surface area 304 of FIG. 3A with an example background pattern 306. FIG. 3C illustrates a resulting hidden surface reconstruction pattern 308 within the hidden surface area 304 if pixels along the left edge 310 of the background pattern 306 are horizontally repeated across the hidden surface area 304. In this example of a bad hidden surface reconstruction, the otherwise natural flow of the transverse background pattern 306 is broken by the horizontal streaks of the hidden surface reconstruction pattern 308. This example of image inconsistency would cause visual attention to be drawn to the hidden surface reconstruction pattern 308, thus resulting as a noticeable image artifact. FIG. 3D illustrates an example of a good reconstruction of the hidden surface area 304. In this example, a hidden surface reconstruction pattern 310 is provided such that it appears to be consistent with, or flows naturally from, the adjacent background pattern 306. In this example, the hidden surface reconstruction pattern 310 is easily accepted by normal human vision as being consistent with its surroundings, and therefore results in no visual artifacts.

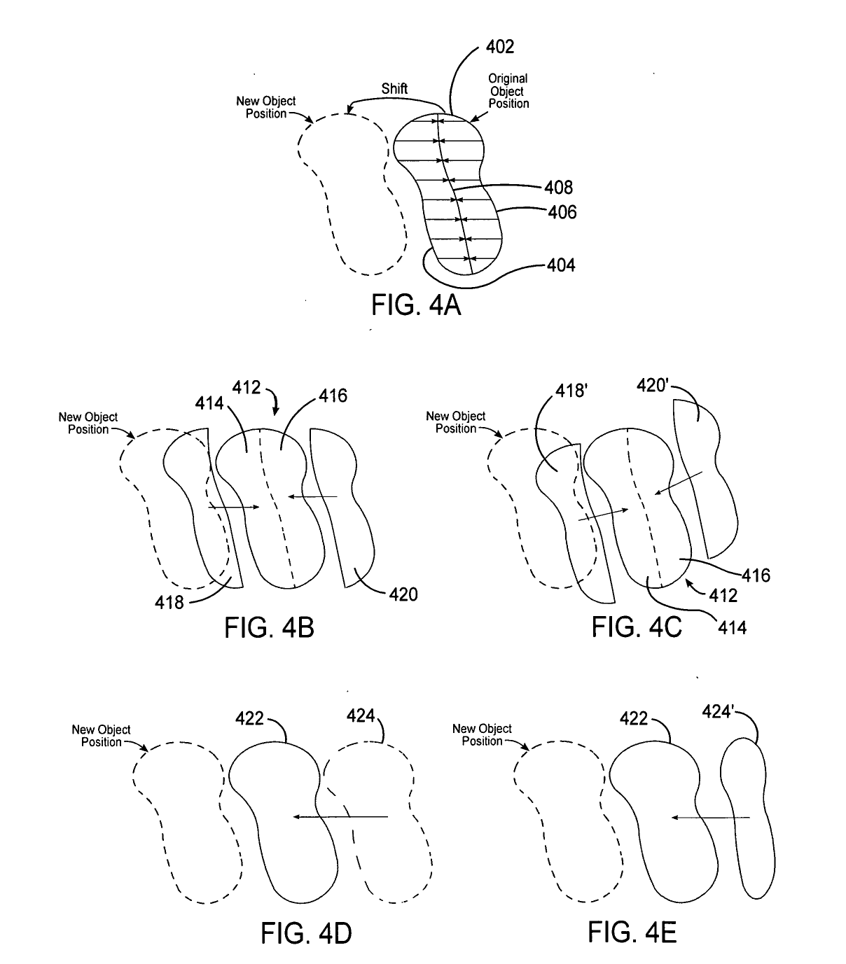

In various embodiments, hidden surface areas are reconstructed by repeating pixels in multiple directions. FIG. 4A illustrates an example of a method for pixel repeating towards a center of a hidden surface area 402. In this example, background pixels are repeated across the hidden surface area 402 from the outside left boundary 404 and the right boundary 406 horizontally towards a center or dividing boundary 408 of the hidden surface area 402. In an example embodiment, if the foreground object happens to completely shift away from its original position, a default pixel repeat pattern can be employed wherein numbers of pixels repeated horizontally for any given row of pixels or other image elements are the same, or symmetrical, from the left and right boundaries 404 and 406 to the center 408. Pixel repeating in this fashion can be automated and serve as a default mode of image reconstruction, e.g., prior to selection by a user of other image content for the hidden surface area. In other embodiments, for example, pixels can be repeated in other directions (such as vertically) and/or toward a point in the hidden surface area (such as a center point, rather than a center line).

In an example embodiment, a method for providing artifact free three-dimensional images converted from two-dimensional images includes identifying a hidden surface area in an image that is part of a three-dimensional image, and reconstructing image content in the hidden surface area by pixel repeating from opposite sides of the hidden surface area towards a center of the hidden surface area.

FIG. 4B illustrates an example of a method for automatically dividing a hidden surface area and placing source selection areas adjacent to the hidden surface area into each portion of the divided hidden surface area. In this example, a hidden surface area 412 is divided into left and right portions 414 and 416, and source selection areas 418 and 420 outside the hidden surface area 412 are selected to provide image content for the left and right portions 414 and 416, respectively. In this example, the source selection areas 418 and 420 are the same size and shape of the left and right hidden surface area portions 414 and 416, respectively. It should be appreciated that this and similar methods can be used to divide a hidden surface area into any number of portions and in any manner desired.

In various embodiments, locations of the source selection areas can be varied for convenience or to find a better, more precise fit of image information. For example, and referring to FIG. 4C, the source selection areas of FIG. 4B can be independently altered to find the best image content for the hidden surface area. In this example, source selection areas 418′ and 420′ (the same size and shape of the left and right hidden surface area portions 414 and 416, respectively, but positioned in the image to include different pixels) are selected instead of the source selection areas 418 and 420 (FIG. 4B).

In an example embodiment, a method for providing artifact free three-dimensional images converted from two-dimensional images includes identifying a hidden surface area in an image that is part of a three-dimensional image, identifying multiple source areas for image content, manipulating one or more of the multiple source areas to change the image content, and using the image content to reconstruct the hidden surface area.

In other embodiments, a single source area can be used to reconstruct a hidden surface area. FIG. 4D illustrates an example method for rapidly reconstructing an entire hidden surface area 422 from an adjacent reconstruction source area 424 (shown in dashed lines). In this example, the reconstruction source area 424 is the same size and shape of the hidden surface area 422, and the entire area of the reconstruction source area 424 is used to capture image information for reconstructing the hidden surface area 422.

In various embodiments, the reconstruction source area can vary in size and/or shape with respect to the hidden surface area. FIG. 4E illustrates an example of how the reconstruction source area of FIG. 4D can be altered, here, to the shape of an alternate reconstruction source area 424′ to find alternate image content for the hidden surface area 422. In this example, the reconstruction source area 424′ is horizontally compressed in width compared to the hidden surface area 422, and the image selection contents are expanded within the hidden surface area 422, e.g., to fill the hidden surface area 422.

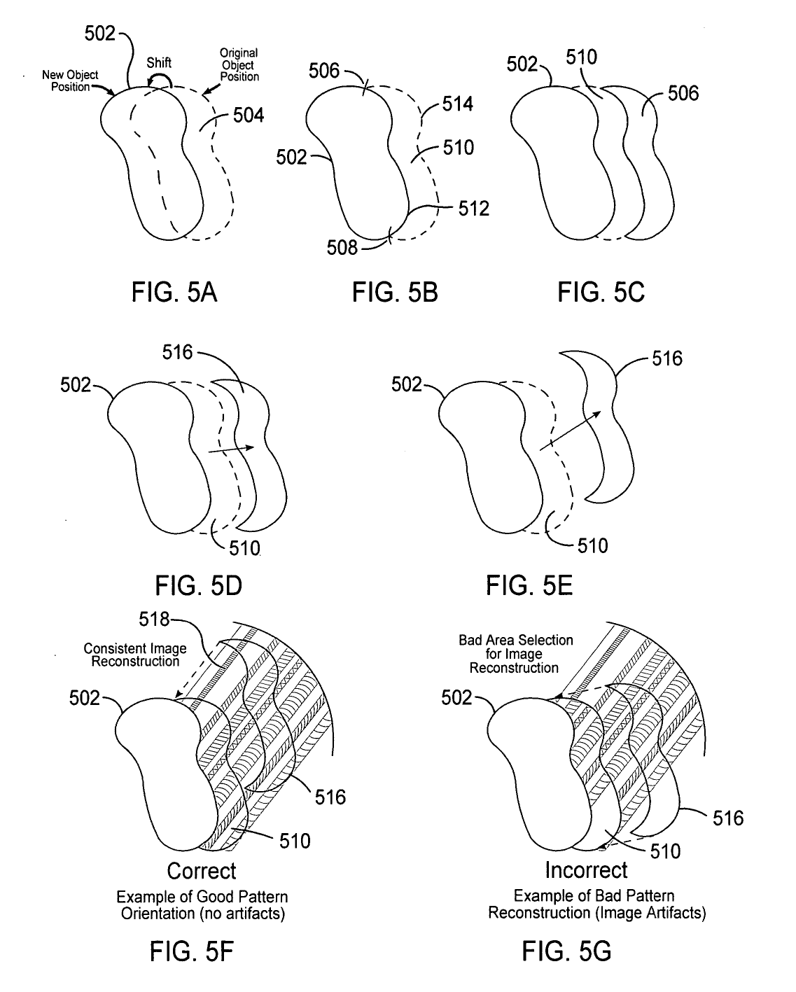

Various embodiments pertain to tools which allow a user to select a group of pixels to serve as a reconstruction area and to determine a group of pixels that will serve as image content for the reconstruction area. FIG. 5A shows an example of an object 502 having shifted in position leaving behind a hidden surface area 504. An example tool is configured to allow a user to easily and quickly select an area of pixels immediately adjacent the shifted object. FIG. 5B illustrates an example method for indicating a selection of an area of hidden surface area to be reconstructed. In this example, the user selects a start point 506 and an end point 508 of the selection area 510 to be reconstructed. The selection area 510 is defined by an object boundary 512 between the start and end points 506 and 508, and by a selection boundary 514 which starts at the start point 506 and ends at the end point 508. By way of example, the distance between the object boundary 512 and the selection boundary 514 can be determined as a function of how much the object 502 was shifted. Also by way of example, this distance can be set to a default value or manually input by a user.

FIG. 5C illustrates an example (e.g., default) reconstruction source area 516 that is automatically generated directly adjacent to the selection area 510 to be reconstructed. In this example, the reconstruction source area 516 has the same size and shape as the selection area 510. As shown in FIGS. 5D and 5E, various embodiments of the present invention also allow the user reposition (e.g. by grabbing and dragging) the reconstruction source area 516. Various embodiments also allow a reconstruction source area 516 to be rotated, resized, or distorted to any shape to select reconstruction information. FIG. 5F illustrates an example of a good image reconstruction with a consistent pattern. In this example, a user repositioned the reconstruction source area 516 in a manner resulting in good pattern continuity transitioning from the background 518 to the selection area 510. FIG. 5G illustrates an example of a bad image reconstruction with an inconsistent pattern resulting in image artifacts where a user repositioned the reconstruction source area 516 to a poor candidate region for reconstruction image content.

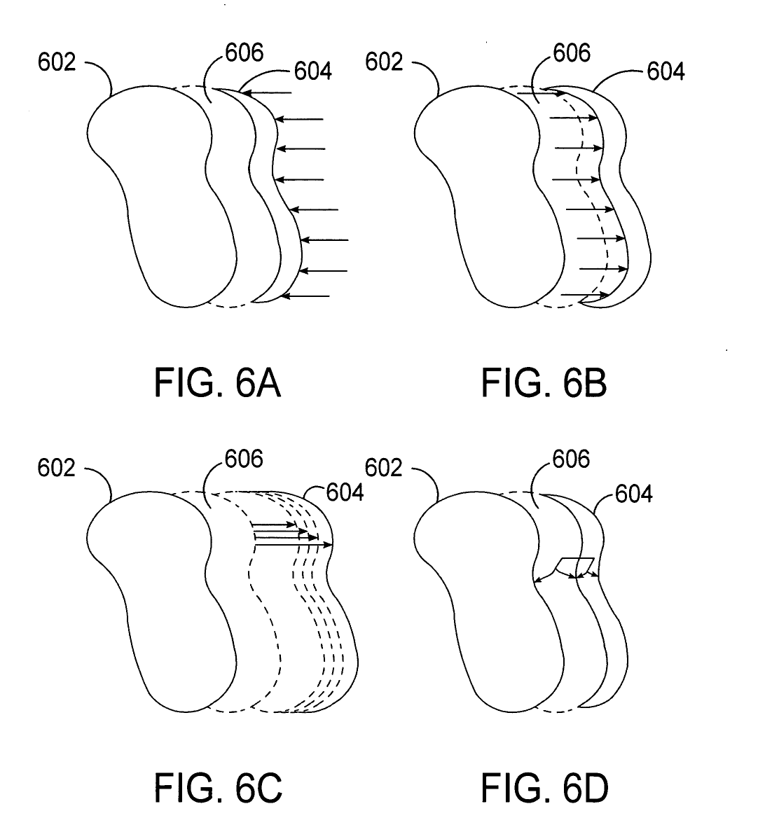

Various embodiments pertain to tools which allow a user to resize, reshape, rotate and/or reposition a reconstruction source selection area. FIGS. 6A and 6B illustrate an example object 602 and hidden surface area 606 and how a user tool can be used to horizontally decrease the size of a reconstruction source area 604 from its right side and left side, respectively. FIG. 6C illustrates how a user tool can be used to incrementally shift the position of the reconstruction source area 604. In this example, the user can either incrementally increase or decrease the width of the reconstruction source area 604 (in relation to the hidden surface area 606) by a specific number of pixels. Alternatively, the width of the reconstruction source area 604 can be adjusted in a continuous variable mode. FIG. 6D illustrates how an example method for reconstructing hidden surface areas automatically re-scales the contents of a reconstruction source area 604 into the hidden surface area 606. For example, as depicted in FIG. 6D, if the user selects a reconstruction source area 604 and reduces the width of that selected area, the pixels that are captured in the selection area are horizontally expanded in the hidden surface area 606.

In an example embodiment, a method for providing artifact free three-dimensional images converted from two-dimensional images includes identifying a hidden surface area in an image that is part of a three-dimensional image, identifying a source area for image content, manipulating a boundary of the source area to change the image content, and using the image content to reconstruct the hidden surface area.

Various embodiments provide a user with one or more “modes” in which selected pixel information is re-fitted into a hidden surface area. By way of example, one mode facilitates a direct one-to-one fit from a selection area to a hidden surface area. Another example mode facilitates automatic scaling from whatever size the selected source area is to the size of the hidden surface area. In an example embodiment, if a user reduces the width of a selection area to a single pixel, the same pixel information will be filled in across the hidden surface area, as if it were pixel repeated across. In another example mode, a one-to-one relationship is retained between pixels in the selection area and what gets applied to the hidden surface area.

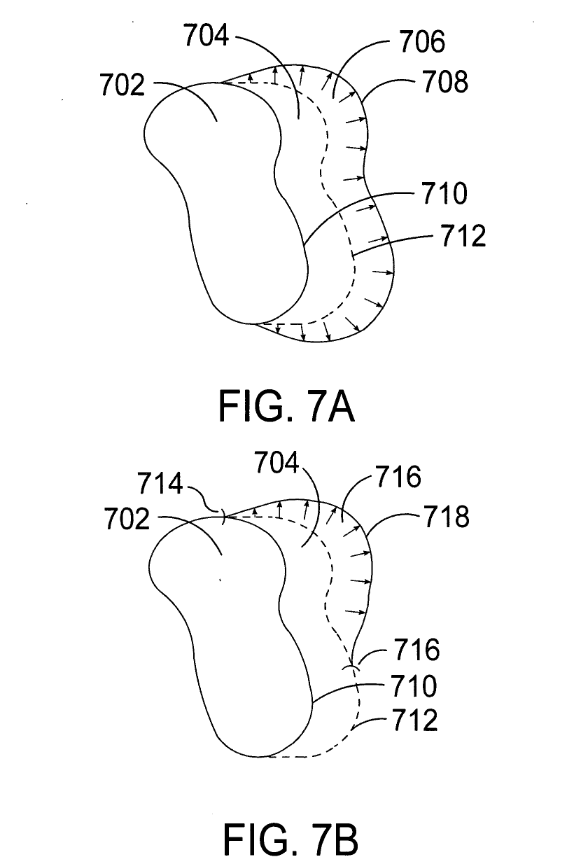

FIG. 7A shows an object 702 shifted to the left and a resulting hidden surface area 704 which is bounded by an object boundary 710 and an outer boundary 712 (shown in dashed lines). As shown, an example method for reconstructing hidden surface areas allows a user to select a mode that automatically generates a reconstruction source area 706 which is bounded by the outer boundary 712 and a generated boundary 708, wherein distances across the hidden surface area 704 (from the object boundary 710 to the outer boundary 712) are used to determine adjacent distances continuing across the reconstruction source area 706 (from the outer boundary 712 to the generated boundary 708). In various embodiments, once generated, the reconstruction source area 706 can also be moved or altered in any way.

In an example embodiment, a method for providing artifact free three-dimensional images converted from two-dimensional images includes, for a hidden surface area in an image that is part of a three-dimensional image, designating a source area adjacent the reconstruction area by proportionally expanding a boundary portion of the hidden surface area, and using image content associated with the source area to reconstruct the hidden surface area.

In another embodiment, FIG. 7B illustrates how an example method for reconstructing hidden surface areas allows a user to select a mode that allows the user to indicate a start point 714 and an end point 716 along an outer boundary 712 of the hidden surface area 704 and to grab and pull the outer boundary 712 to form a reconstruction source area 716 which is bounded by the outer boundary 712 and a selected boundary 718. In various embodiments, selected pixel areas can be defined and/or modified by grabbed and stretching or bending the boundaries of such areas as desired.

In U.S. patent application Ser. No. 10/316,672 entitled “Method Of Hidden Surface Reconstruction For Creating Accurate Three-Dimensional Images Converted From Two-Dimensional Images”, methods were described that allow a user to obtain hidden surface area information in other frames, as image content for hidden surface areas becomes revealed by objects having moved. Even though information missing from an image can usually be reconstructed using image content available within that image, it is sometimes more accurate to use original picture information from a different frame if it is available.

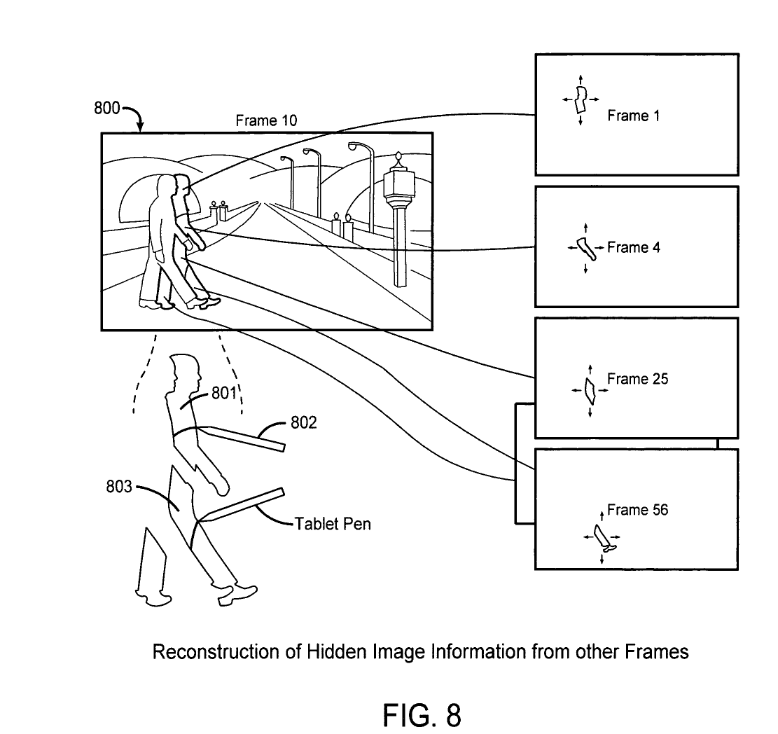

FIG. 8 illustrates an example of hidden surface reconstruction using source image content from other frames. Various embodiments pertain to interactive tools designed to allow the user to obtain pixels from any number of images or frames. This functionality accommodates the fact that useful pixels may become revealed at different moments in time in other frames as well as at different locations within an image. FIG. 8 illustrates an exaggerated example where the pixel fill gaps of an image 800 (Frame 10) are filled by pixels from more than one frame. By way of example, the interactive user interface can be configured to allow the user to divide a pixel fill area 801 (e.g., with a tablet pen 802) to use a different set of pixels from different frames, in this case, Frames 1 and 4, for each of the portions of the pixel fill area 801. Similarly, the pixel fill area 803 can be divided to use different pixel fill information retrieved from Frames 25 and 56 for each of the portions of the pixel fill area 803. Ideally, the user is provided with complete flexibility to obtain pixel fill information from any combination of images or frames in order to obtain a best fit and match of background pixels.

Various embodiments pertain to tools that allow a user to correct multiple frames in an efficient and accurate manner. For example, once a user has employed a conversion process (such as the DIMENSIONALIZATION® process developed by In-Three, Inc. of Agoura Hills, Calif.) to provide a sequence of 3D images, various embodiments of the present invention provide the user with the ability to reconstruct hidden surface areas in the sequence of 3D images.

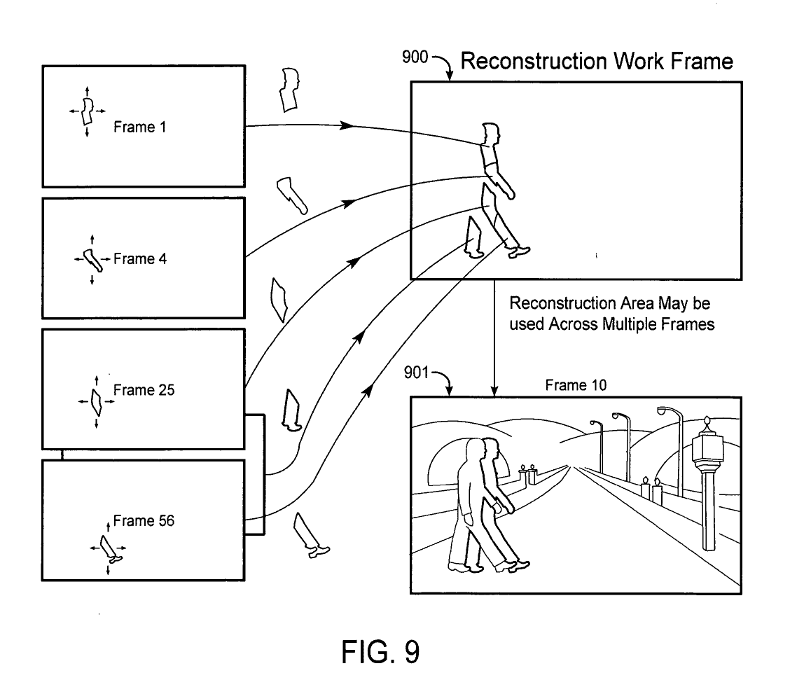

Various embodiments pertain to tools that allow a user to utilize the same information that was used to reconstruct the hidden surface areas of one frame to reconstruct hidden surface areas of other frames in a sequence of images. This eliminates the need for the user to have to reconstruct hidden surface areas of each and every frame. Referring to FIG. 9, in an example embodiment, a reconstruction work frame 900 is used to reconstruct areas of image reconstruction information from multiple source frames (denoted “Frame 1”, “Frame 4”, “Frame 25” and “Frame 56”). The reconstruction work frame 900 can be used to assemble image information from one or more image frames. The reconstruction information from the reconstruction work frame 900 can be used over and over again in multiple frames. As shown in this example, the reconstruction information assembled within the reconstruction work frame 900 is used to reconstruct hidden surface areas in an image 901 (denoted “Frame 10”). Interactive tools permitting a user to create, store and access multiple reconstruction work frames can also be provided.

In an example embodiment, a method for providing artifact free three-dimensional images converted from two-dimensional images includes assembling portions of image information from one or more frames into one or more reconstruction work frames, and using the assembled portions of image information from the work frames to reconstruct an image area of one or more images that are part of a sequence of three-dimensional images.

In an example embodiment, a method for providing artifact free three-dimensional images converted from two-dimensional images includes assembling portions of image information from one or more frames into one or more reconstruction work frames, using the assembled portions of image information from the work frames to reconstruct an image area to one or more images that are part of a sequence of three-dimensional images, receiving and accessing the image data, and reproducing the images as three-dimensional images whereby a viewer perceives depth.

An important aspect of hidden surface reconstruction for a sequence of images is the relationship of image information from one frame to the next as objects move about over time. Even if high quality picture information from other frames is used to reconstruct hidden image areas (such that each frame appears to have an acceptable correction when individually viewed), the entire running sequence still needs to be viewed to ensure that the reconstruction of the hidden surface areas is consistent from frame to frame. With different and/or inconsistent corrections from frame to frame, motion artifacts may be noticeable at the reconstructed areas as each frame advances in rapid succession. Such corrections may produce a worse effect than if no correction of the hidden surface areas was attempted at all. To provide continuity of the corrected areas with motion, various embodiments described below pertain to tracking corrections of hidden surface areas over multiple image frames.

Wandering Area Detection:

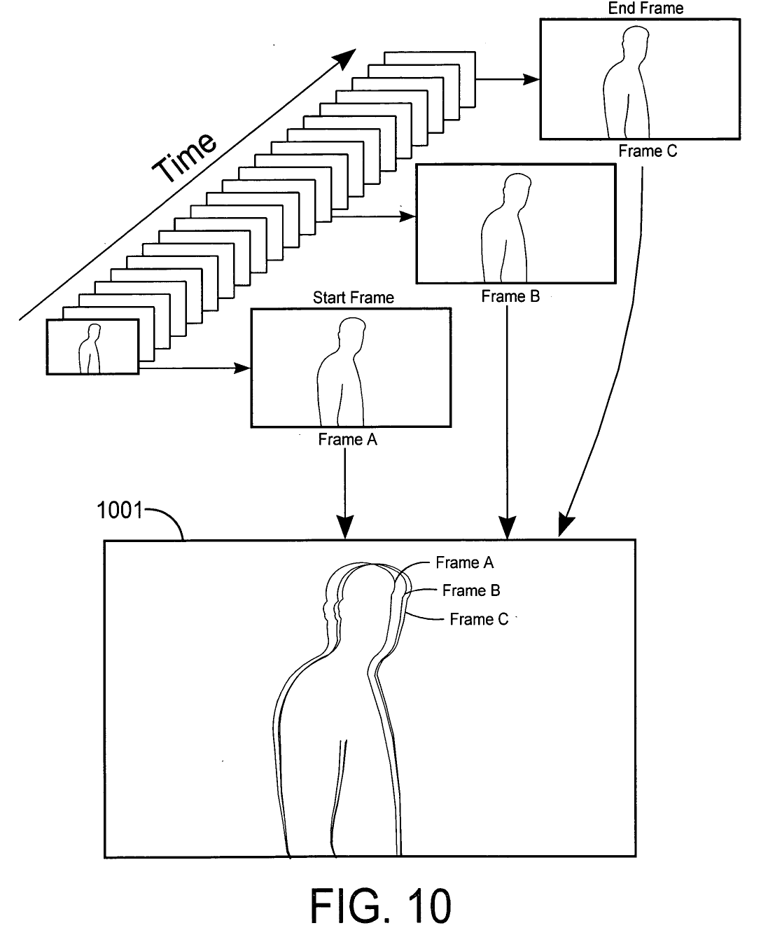

Objects in a sequence of motion picture images typically do not stay in fixed positions. Even with stationary objects, slight movements tend to occur. Various embodiments for reconstructing hidden surface areas take into account or track movements of objects. Such functionality is useful in a variety of circumstances. By way of example, and referring to FIG. 10, as the person's head moves from side to side in a sequence of frames it will often reveal hidden picture information valuable to the reconstruction of hidden surface areas. In this example, as time progresses from “Frame A” to “Frame B” to “Frame C”, subtle movements occur even though the sequence may appear to be, and is considered to be, a relatively static shot. As shown in the image 1001 in FIG. 10, the subtle positional changes can be more easily seen when the object outlines are overlaid.

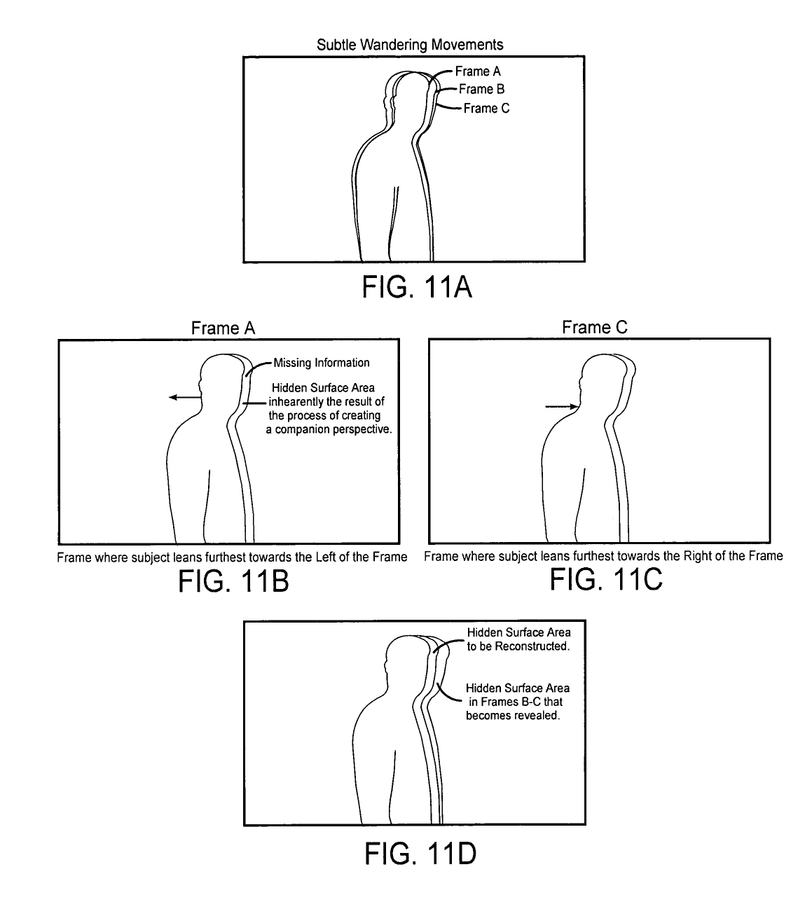

Various embodiments pertain to tools that allow a user to select a sequence of frames, representing a time sequence, and have the maximum amount of the hidden surface areas of objects determined, as those objects move within that time sequence. FIGS. 11A-11D illustrate an example feature for automatically determining a maximum hidden surface area to be reconstructed for a sequence of images. This feature saves time for the user since the maximum hidden surface area is determined automatically rather than the user having to hunt through a number of frames to try to determine the maximum area of reconstruction.

In an example embodiment, a method for providing artifact free three-dimensional images converted from two-dimensional images includes identifying multiple images in a sequence of three-dimensional images, processing the multiple images to determine changes in a boundary of an image object that is common to at least two of the images, and analyzing the changes in the boundary to determine a maximum hidden surface area associated with changes to the image object as the boundaries of the image object change across a sequence of frames representing motion and time.

Reconstruction Area Tracking:

As noted above, in motion pictures it is rare when objects remain perfectly stationary from frame to frame. Even with locked off camera shots there is usually some subtle movement. Additionally, cameras will often track subtle movements of foreground objects. This results in background objects moving in relation to foreground objects. As object movement occurs, as subtle as it may be, it is often important that reconstructed areas track the objects that they are a part of in order to stay consistent with object movement. If reconstructed areas do not track the movement of the object(s) that they are part of, a reconstructed surface which stays stationary, for example, may be visible as a distracting artifact.

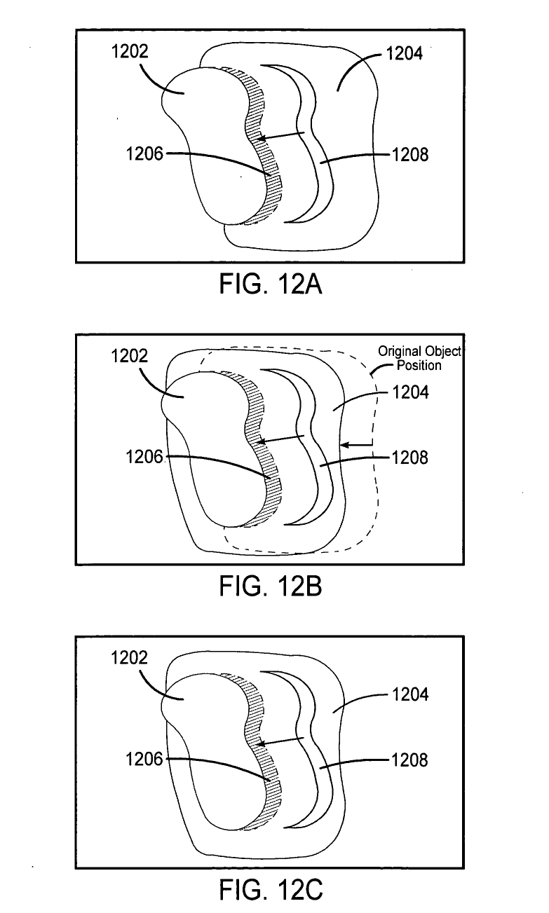

FIG. 12A illustrates an example of a foreground object 1202 having shifted in position in relation to a background object 1204, leaving a hidden surface area 1206, and a source area 1208 to be used in reconstructing the hidden surface area 1206. FIG. 12B illustrates the background object 1204 having shifted, and how an example method for hidden surface reconstruction results in the source area 1208 tracking the change. In this example, as shown in FIG. 12C, the source area 1208 tracks with the new position of an object as it has changed in a different frame.

In an example embodiment, a method for providing artifact free three-dimensional images converted from two-dimensional images includes tracking changes to a source area of image information to be used to reconstruct a hidden surface area in an image that is part of a three-dimensional image over a sequence of three-dimensional images, and adjusting a source area defining image content for reconstructing the hidden surface area in response to the changes in an area adjacent to the hidden surface area.

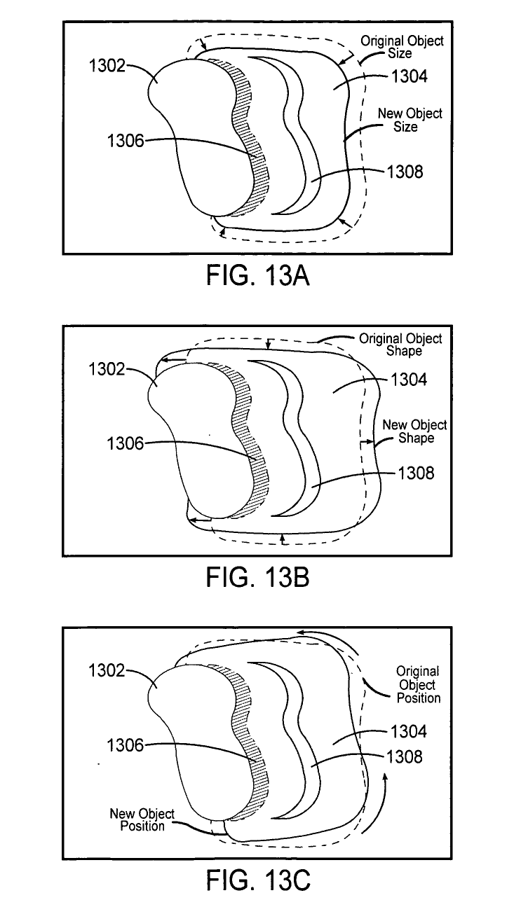

FIG. 13A illustrates an example of a foreground object 1302 having shifted in position in relation to a background object 1304, leaving a hidden surface area 1306, and a source area 1308 to be used in reconstructing the hidden surface area 1306. This figure shows an example method for hidden surface reconstruction that causes the source area 1302 to maintain its position relative to the hidden surface area 1306 when the background object 1304 changes in size. In this example, the background object 1304 is decreased in size, however the source area 1308 maintains its position in relation to the hidden surface area 1306. FIG. 13B illustrates an example method for hidden surface reconstruction that causes the source area 1308 to maintain its position relative to the hidden surface area 1306 when the background object 1304 changes in shape. FIG. 13C illustrates an example method for hidden surface reconstruction that causes the source area 1308 to maintain its position relative to the hidden surface area 1306 when the background object 1304 changes in position. In these examples, the source area 1308 is maintained in its position relative to the frame to provide a more consistent reconstruction of the hidden surface area 1306.

In an example embodiment, a method for converting two-dimensional images into three-dimensional images includes tracking an image reconstruction of hidden surface areas to be consistent with image areas adjacent to the hidden surface areas over a sequence of frames making up a three-dimensional motion picture.

In an example embodiment, a method for providing artifact free three-dimensional images converted from two-dimensional images includes tracking changes in an object in an image that is part of a three-dimensional image over a sequence of three-dimensional images, the object including a source area that defines image content for reconstructing a hidden surface area in the image, and adjusting the source area in response to the changes in the object.

In an example embodiment, a method for providing artifact free three-dimensional images converted from two-dimensional images includes tracking hidden surface areas in a motion picture sequence of frames in order to reconstruct the hidden surface areas in the frames with image information consistent with surroundings of the hidden surface areas, and receiving and accessing data in order to present the frames as three-dimensional images whereby a viewer perceives depth.

In an example embodiment, a method for providing artifact free three-dimensional images converted from two-dimensional images includes tracking hidden surface areas in a motion picture sequence of frames in order to reconstruct the hidden surface areas in the frames with image information consistent with surroundings of the hidden surface areas, and reproducing the frames as three-dimensional images whereby a viewer perceives depth.

It should be understood that in some instances exaggerated or disproportionate examples have been provided. In the figures, even though the source areas are shown to be the same size as the hidden surface areas, in practice the source areas can be larger to encompass enough reconstruction area to allow for changes in the shape, size and/or position of objects. In various embodiments, when the source area is larger than the hidden surface area to be filled, only a portion of the source area (e.g., identical in size and shape to the hidden surface area) is used to fill the hidden surface area. In such embodiments, the remainder of the source area serves as reserve image content to allow for movement of and changes made to the object. As discussed below, it is important to prevent or at least minimize reconstruction of pixels outside of exposed hidden surface areas.

I. Alpha Channel Selective Area Reconstruction:

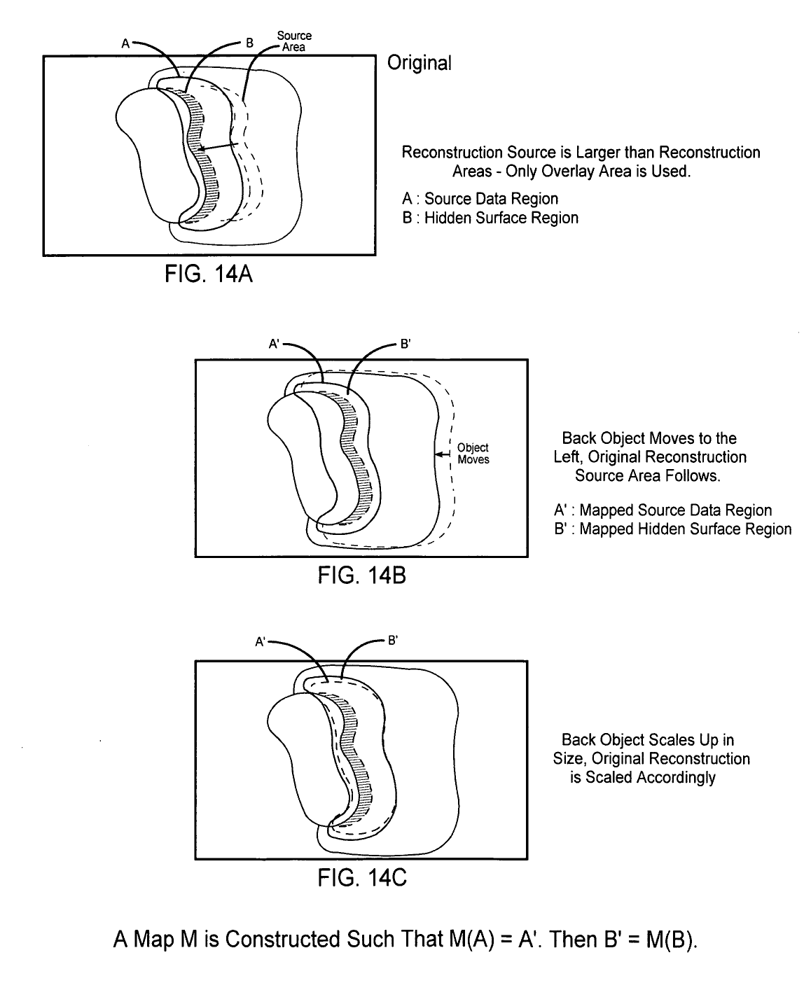

Various embodiments pertain to automatically restricting hidden surface reconstruction to pixels within hidden surface areas. FIG. 14A shows a Source Data Region A used to reconstruct a Hidden Surface Region B. As discussed above, the reconstruction source area can be larger than the hidden surface area. In this example, only the area of the Source Data Region A that overlays the Hidden Surface Region B is used; the remaining portion of the Source Data Region A is “masked” in some fashion, e.g., employing an alpha channel to assign a low level of opacity (e.g., zero), or conversely, a high level of transparency. Thus if the source image is larger than the hidden surface reconstruction area, as in FIG. 14A, only the portion of the source image intersecting the closure of the reconstruction area will be used. This makes it possible to overlay an oversized source image without adding any visual disparity between the left and right perspective frames, thereby providing greater flexibility for hidden surface area reconstruction in frame sequences. Further to this end, FIGS. 14B and 14C illustrate how an example method for hidden surface reconstruction causes a Source Data Region to track changes in the background object.

In an example embodiment, a method for providing artifact free three-dimensional images converted from two-dimensional images includes tracking changes to an object in an image that is part of a three-dimensional image over a sequence of three-dimensional images, the object including a source area defining image content for reconstructing a hidden surface area in the image, and selecting portions of the source area to be used for reconstructing the hidden surface area depending upon the changes to the object.

II. Tracking Hidden Surface Reconstruction Area Deformation:

Once a hidden surface reconstruction area has been defined and reconstructed in a single frame of a sequence, it is important, for both frame-to-frame image consistency and user efficiency, to have functionality that makes it possible for deformations in the reconstruction area to be tracked over some set of preceding and/or following frames in the sequence, and for the source image used to reconstruct the original hidden surface reconstruction area to be deformed to match the deformed reconstruction area. Thus, various embodiments provide a mechanism for the user to reconstruct an area in only a single frame and have that reconstruction generate a valid (consistent) reconstruction for the associated area in previous and/or following frames in the sequence. Examples of implementation approaches are described below.

Determining Reconstruction Area Deformation Over Time

III. Boundary-to-Boundary Isomorphic Mapping Strategy:

In U.S. patent application Ser. No. 10/316,672 entitled “Method Of Hidden Surface Reconstruction For Creating Accurate Three-Dimensional Images Converted From Two-Dimensional Images”, methods were described for automatically determining areas of a converted 2D to 3D image where object shifting has created a surface hidden in the original frame to be exposed in the secondary perspective frame generated by the 2D to 3D conversion process. Once an exposed area has been chosen, its associated area in any other frame can be determined, if it exists. Thus, given a reconstruction area in any frame in a sequence, a method is provided for determining the existence of an associated reconstruction area in any other frame in the sequence and for determining the shape of the associated area.

Once a reconstruction area in a second frame associated with a reconstruction area in an original frame has been determined, an approximate isomorphic mapping between the two areas can be computed from the boundaries. This mapping can then be applied, in an appropriate sense, to the reconstruction source image used in the original frame to automatically generate a reconstruction source for the reconstruction area in the second frame.

IV. Particular Pixel Image Tracking Strategy

In general, a user can define any number of points within an image that may be “tracked” to or found in other images, e.g., previous or subsequent frames in a sequence via implementation of technologies such as “pattern matching”, “image differencing”, etc.

With respect to particular pixel tracking/recognition methods, by way of example, a user can select significant pixels on the pertinent object near, but outside of, the reconstruction area (as there is no valid image data to track inside of the reconstruction area) to track in previous or subsequent frames within the sequence. The motion of each tracked pixel can be followed as a group to again build an approximate locally isomorphic map of the object deformation local to the desired area of reconstruction. As in section I above, this map can be applied to the original source image to produce a reconstruction source image for the new frame.

V. Comparison of Methods:

While the two strategies discussed above are comparable in that a locally isomorphic map approximates the deformation of a body of image pixels across adjacent frames in a sequence, as between the two strategies, both the input needed and the method for constructing the map are considerably different.

The method discussed in section I requires no user input for the construction of the map, rather it relies only on boundary data. In general, this will produce a very accurate fit for the image boundary, but may not accurately reflect behavior on the interior. In other words, it cannot be assumed that interior conditions in the deformation are determined entirely by the conditions on the boundary. However, across several frames in a sequence, the map construction will be regular so that the approximated source image for the reconstruction area will be regular across the sequence. Combined with the fact that, at most, the boundary of the hidden surface area is visible in the original frame perspective of any given frame set in the sequence, this will generally produce no undesirable disparities between the two frame perspectives.

The method discussed in section II requires more user input—in the form of pixels to be tracked—but may utilize local data from outside of the reconstruction area as well as data from the boundary, to pair local boundary data with more global data about the deformation of the object that is being reconstructed. This, in turn, may lead to a more accurate portrayal of what is happening inside of the deforming reconstruction region. On a case-by-case basis, it can be determined whether a possible difference in accuracy merits utilization of more input data.

Mirror Pattern Selection:

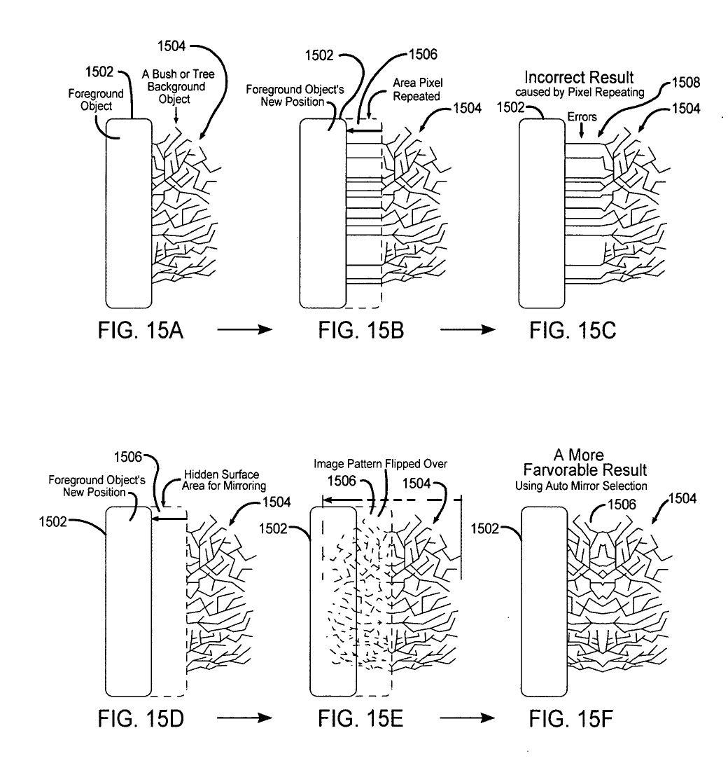

Various embodiments pertain to providing image information to hidden surface areas by mirroring a source area. In some instances, hidden surface areas can be suitably reconstructed by flipping, or rather, mirroring an adjacent source area (for example, by having a mirrored pattern from a nearby source area filled in across the hidden surface area). Examples of source areas that are often suitable for such mirroring include images of bushes, clusters of tree branches, and fence patterns. FIG. 15A illustrates an example foreground object 1502 against a bush or tree branches background object 1504. FIG. 15B illustrates the foreground object 1502 having moved revealing a hidden surface area 1506. As shown in FIG. 15C, if a simple pixel repeat method is used the resulting pattern 1508 will be so inconsistent with the adjacent pattern (of the background object 1504) that the pixel repeated pattern 1508 will be perceived as a distracting artifact. On the other hand, FIGS. 15D-15F illustrate an example method for hidden surface reconstruction that mirrors, or flips, image content adjacent the hidden surface area to cover the hidden surface area 1506. In this example, the image content of the background object 1504 is flipped as shown to overlay the hidden surface area 1506. In this example, as shown in FIG. 15F, only portions of the flipped pattern that overlay the hidden surface area 1506 are used to reconstruct pixels in the image (e.g., employing alpha-blending or the like as discussed above). Thus, various embodiments of the present invention provide Auto Mirror functionality.

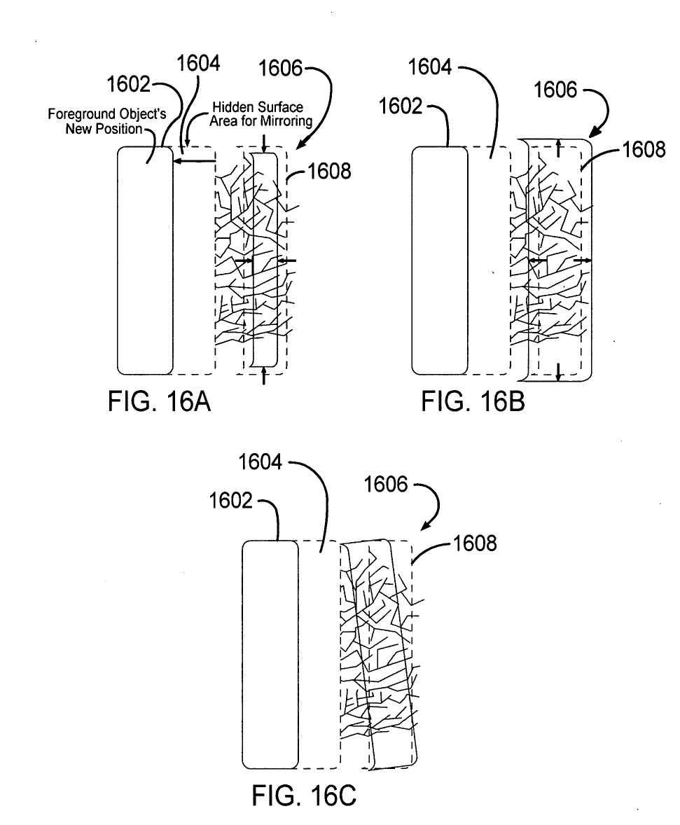

Various embodiments pertain to tools that allow a user to adjust the size or position of a source selection area or “candidate region”. FIG. 16A illustrates an example foreground object 1602 shifted to the left leaving a hidden surface area 1604, and a background 1606 including a candidate source selection area 1608 (shown in dashed lines) to be filled in to the hidden surface area 1604. FIG. 16A illustrates an example of how the source selection area 1608 can be decreased in size, both horizontally and vertically. FIG. 16B illustrates an example of how the source selection area 1608 can be increased in size. FIG. 16C illustrates an example of how the source selection area 1608 can be rotated.

In an example embodiment, a method for providing artifact free three-dimensional images converted from two-dimensional images includes identifying a hidden surface area in an image that is part of a three-dimensional image, identifying a source area of the image that is adjacent the hidden surface area, and reconstructing the hidden surface area with a mirrored version of image content from the source area.

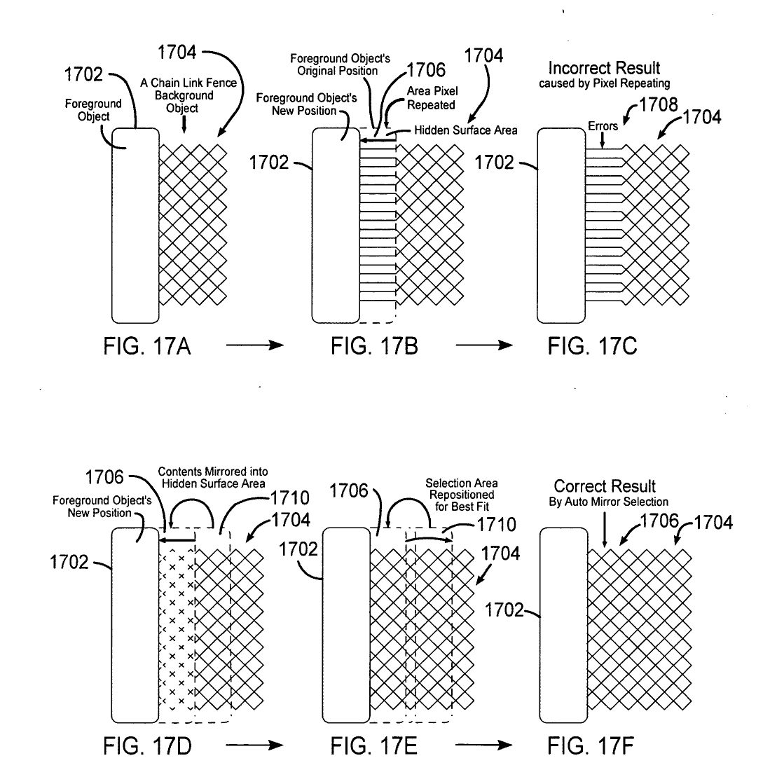

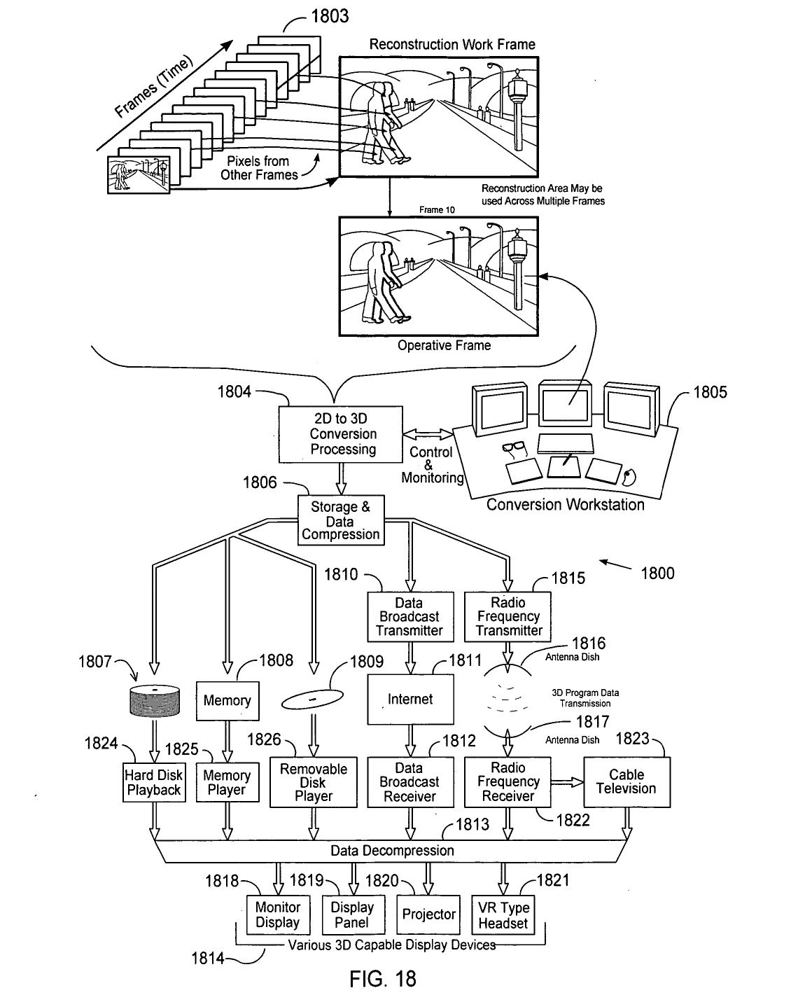

FIG. 17A illustrates an example foreground object 1702 against a chain link fence background object 1704. FIG. 17B illustrates the foreground object 1702 having moved revealing a hidden surface area 1706. As shown in FIG. 17C, if a simple pixel repeat method is used the resulting pattern 1708 will be so inconsistent with the adjacent pattern (of the background object 1704) that the pixel repeated pattern 1708 will be perceived as a distracting artifact. On the other hand, FIGS. 17D-17F illustrate an example method for hidden surface reconstruction that mirrors, or flips, and repositions image content adjacent the hidden surface area to cover the hidden surface area 1706. In this example, the image content of a selection area 1710, which is the same size as the hidden surface area 1706 in the interest of speed of operation, is flipped as shown to directly overlay the hidden surface area 1706. Referring to FIG. 17E, the user may then chose to grab and move the selection area 1710 to a better area of selection which results in a better fit as shown. In an example embodiment, an interactive user interface is configured such that, as the user moves the selection area 1710, the source information appears in the hidden surface area 1706 in real time. FIG. 17F illustrates the end result of the mirroring and repositioning of FIG. 17E, when a good match of source pixels is selected to fill the hidden surface area 1706 with a pattern that is consistent with the pattern of the adjacent background object 1704. Thus, various embodiments of the present invention provide a user with control over Auto Mirror Selection functionality.

When processing images with large pixel sizes, the amount of computer processing time involved is typically a consideration. Larger sized images result in larger file sizes and greater memory and processing time requirements, and therefore the entire 2D to 3D conversion process can become slower. For example, increasing an image pixel size from 2048 by 1080 to 4096 by 2160 quadruples the file size. A conversion workstation may not be equipped with working monitors that display anywhere near 4000 pixels across, but rather working monitors that, for example, produce on the order of 1200 pixels across in actuality.

In various embodiments, larger sized images are scaled down (e.g., by two to one) and analysis, assignment of depth placement values, processing, etc. are performed on the resulting smaller scale images. Utilizing this technique allows the user to operate with much greater speed through the DIMENSIONALIZATION® 2D to 3D conversion process. Once the DIMENSIONALIZATION® decisions are made, the system can internally process the high-resolution files either on the same computer workstation or on a separate independent workstation not encumbering the DIMENSIONALIZATION® workstation.

In various embodiments, high-resolution files are automatically downscaled within the software process and presented to the workstation monitor. As the operator processes the images into 3D the object files that contain the depth information are also created in the same scale, proportional to the image. During the final processing of the high-resolution files, the object files containing the depth information are also scaled up to follow and fit to the high-resolution file sizes. The information containing the DIMENSIONALIZATION® decisions is also appropriately scaled.

Various principles of the present invention are embodied in an interactive user interface and image processing tools that allow a user to rapidly convert a large number of images or frames to create authentic and realistic appearing three-dimensional images. In the illustrated example system 1800, the 2D-to-3D conversion processing, indicated at block 1804, is implemented and controlled by a user working at a conversion workstation 1805. It is here, at a conversion workstation 1805, that the user gains access to the interactive user interface and the image processing tools and controls and monitors the results of the 2D-to-3D conversion processing. It should be understood that the functions implemented during the 2D-to-3D processing can be performed by one or more processor/controller. Moreover, these functions can be implemented employing a combination of software, hardware and/or firmware taking into consideration the particular requirements, desired performance levels, etc. for a given system or application.

The three-dimensional converted product and its associated working files can be stored (storage and data compression 1806) on hard disk, in memory, on tape, or on any other data storage device. In the interest of conserving space on the above-mentioned storage devices, it is standard practice to data compress the information; otherwise files sizes can become extraordinarily large especially when full-length motion pictures are involved. Data compression also becomes necessary when the information needs to pass through a system with limited bandwidth, such as a broadcast transmission channel, for instance, although compression is not absolutely necessary to the process if bandwidth limitations are not an issue.

The three-dimensional converted content data can be stored in many forms. The data can be stored on a hard disk 1807 (for hard disk playback 1824), in removable or non-removable memory 1808 (for use by a memory player 1825), or on removable disks 1809 (for use by a removable disk player 1826), which may include but are not limited to digital versatile disks (dvd's). The three-dimensional converted product can also be compressed into the bandwidth necessary to be transmitted by a data broadcast receiver 1810 across the Internet 1811, and then received by a data broadcast receiver 1812 and decompressed (data decompression 1813), making it available for use via various 3D capable display devices 1814 (e.g., a monitor display 1818, possibly incorporating a cathode ray tube (CRT), a display panel 1819 such as a plasma display panel (PDP) or liquid crystal display (LCD), a front or rear projector 1820 in the home, industry, or in the cinema, or a virtual reality (VR) type of headset 1821.) Similar to broadcasting over the Internet, the product created by the present invention can be transmitted by way of electromagnetic or radio frequency (RF) transmission by a radio frequency transmitter 1815. This includes direct conventional television transmission, as well as satellite transmission employing an antenna dish 1816. The content created by way of the present invention can be transmitted by satellite and received by an antenna dish 1817, decompressed, and viewed or otherwise used as discussed above. If the three-dimensional content is broadcast by way of RF transmission, a receiver 1822 can in feed decompression circuitry directly, or feed a display device directly. Either is possible. It should be noted however that the content product produced by the present invention is not limited to compressed data formats. The product may also be used in an uncompressed form. Another use for the product and content produced by the present invention is cable television 1823.

In an example embodiment, a method for converting two-dimensional images into three-dimensional images includes employing a system that tracks an image reconstruction of hidden surface areas to be consistent with image areas adjacent to the hidden surface areas over a sequence of frames making up a three-dimensional motion picture.

In an example embodiment, a system for providing artifact free three-dimensional images converted from two-dimensional images includes an interactive user interface configured to allow a user to track changes in an object in an image that is part of a three-dimensional image over a sequence of three-dimensional images, the object including a source area that defines image content for reconstructing a hidden surface area in the image, and adjust the source area in response to the changes in the object.

In an example embodiment, a system for providing artifact free three-dimensional images converted from two-dimensional images includes an interactive user interface configured to allow a user to track changes to an object in an image that is part of a three-dimensional image over a sequence of three-dimensional images, the object including a source area defining image content for reconstructing a hidden surface area in the image, and select portions of the source area to be used for reconstructing the hidden surface area depending upon the changes to the object.

In an example embodiment, a system for providing artifact free three-dimensional images converted from two-dimensional images includes an interactive user interface configured to allow a user to assemble portions of image information from one or more frames into one or more reconstruction work frames, and use the assembled portions of image information from the work frames to reconstruct an image area of one or more images that are part of a sequence of three-dimensional images.

In an example embodiment, an article of data storage media is used to store images, information or data created employing any of the methods or systems described herein.

In an example embodiment, a method for providing a three-dimensional image includes receiving or accessing data created employing any of the methods or systems described herein and employing the data to reproduce a three-dimensional image.

Although the present invention has been described in terms of the example embodiments above, numerous modifications and/or additions to the above-described embodiments would be readily apparent to one skilled in the art. It is intended that the scope of the present invention extend to all such modifications and/or additions.

1. A method for converting two-dimensional images into three-dimensional images, comprising:
tracking an image reconstruction of hidden surface areas to be consistent with image areas adjacent to the hidden surface areas over a sequence of frames making up a three-dimensional motion picture.

2. A method for converting two-dimensional images into three-dimensional images, comprising:
employing a system that tracks an image reconstruction of hidden surface areas to be consistent with image areas adjacent to the hidden surface areas over a sequence of frames making up a three-dimensional motion picture.

3. A method for providing artifact free three-dimensional images converted from two-dimensional images, comprising:
tracking changes to a source area of image information to be used to reconstruct a hidden surface area in an image that is part of a three-dimensional image over a sequence of three-dimensional images; and
adjusting a source area defining image content for reconstructing the hidden surface area in response to the changes in an area adjacent to the hidden surface area.

4. A method for providing artifact free three-dimensional images converted from two-dimensional images, comprising:
tracking changes in an object in an image that is part of a three-dimensional image over a sequence of three-dimensional images, the object including a source area that defines image content for reconstructing a hidden surface area in the image; and
adjusting the source area in response to the changes in the object.

5. The method for providing artifact free three-dimensional images converted from two-dimensional images of claim 4, wherein the source area is adjusted in response to changes in a size of the object.

6. The method for providing artifact free three-dimensional images converted from two-dimensional images of claim 4, wherein the source area is adjusted in response to changes in a shape of the object.

7. The method for providing artifact free three-dimensional images converted from two-dimensional images of claim 4, wherein the source area is adjusted in response to changes in a position of the object.

8. A system for providing artifact free three-dimensional images converted from two-dimensional images, comprising:
an interactive user interface configured to allow a user to
track changes in an object in an image that is part of a three-dimensional image over a sequence of three-dimensional images, the object including a source area that defines image content for reconstructing a hidden surface area in the image, and
adjust the source area in response to the changes in the object.

9. A method for providing artifact free three-dimensional images converted from two-dimensional images, comprising:
tracking changes to an object in an image that is part of a three-dimensional image over a sequence of three-dimensional images, the object including a source area defining image content for reconstructing a hidden surface area in the image; and
selecting portions of the source area to be used for reconstructing the hidden surface area depending upon the changes to the object.

10. The method for providing artifact free three-dimensional images converted from two-dimensional images of claim 9, wherein the source area is larger than the hidden surface area.

11. The method for providing artifact free three-dimensional images converted from two-dimensional images of claim 9, wherein the changes to the object are in size.

12. The method for providing artifact free three-dimensional images converted from two-dimensional images of claim 9, wherein the changes to the object are in shape.

13. The method for providing artifact free three-dimensional images converted from two-dimensional images of claim 9, wherein the changes to the object are in position.

14. The method for providing artifact free three-dimensional images converted from two-dimensional images of claim 9, wherein an alpha blending process is employed to select the portions of the source area.

15. A system for providing artifact free three-dimensional images converted from two-dimensional images, comprising:
an interactive user interface configured to allow a user to
track changes to an object in an image that is part of a three-dimensional image over a sequence of three-dimensional images, the object including a source area defining image content for reconstructing a hidden surface area in the image, and
select portions of the source area to be used for reconstructing the hidden surface area depending upon the changes to the object.

16. A method for providing artifact free three-dimensional images converted from two-dimensional images, comprising:
identifying a hidden surface area in an image that is part of a three-dimensional image; and
reconstructing image content in the hidden surface area by pixel repeating from opposite sides of the hidden surface area towards a center of the hidden surface area.

17. The method for providing artifact free three-dimensional images converted from two-dimensional images of claim 16, wherein the opposite sides are left and right borders of the hidden surface area.

18. A method for providing artifact free three-dimensional images converted from two-dimensional images, comprising:
identifying a hidden surface area in an image that is part of a three-dimensional image;
identifying multiple source areas for image content;
manipulating one or more of the multiple source areas to change the image content; and
using the image content to reconstruct the hidden surface area.

19. The method for providing artifact free three-dimensional images converted from two-dimensional images of claim 18, wherein manipulating includes repositioning one or more of the multiple source areas.

20. The method for providing artifact free three-dimensional images converted from two-dimensional images of claim 18, wherein manipulating includes resizing one or more of the multiple source areas.

21. The method for providing artifact free three-dimensional images converted from two-dimensional images of claim 18, wherein manipulating includes reshaping one or more of the multiple source areas.

22. The method for providing artifact free three-dimensional image converted from two-dimensional image of claim 18, wherein the multiple source areas are from different frames.

23. A method for providing artifact free three-dimensional images converted from two-dimensional images, comprising:
identifying a hidden surface area in an image that is part of a three-dimensional image;
identifying a source area for image content;
manipulating a boundary of the source area to change the image content; and
using the image content to reconstruct the hidden surface area.

24. The method for providing artifact free three-dimensional images converted from two-dimensional images of claim 23, wherein identifying the source area includes designating start and end points of the source area.

25. The method for providing artifact free three-dimensional images converted from two-dimensional images of claim 24, wherein the start and end points intersect a boundary portion of the hidden surface area.

26. The method for providing artifact free three-dimensional images converted from two-dimensional images of claim 23, wherein identifying the source area includes automatically selecting a default position for the source area.

27. The method for providing artifact free three-dimensional images converted from two-dimensional images of claim 26, wherein the default position is adjacent the hidden surface area.

28. The method for providing artifact free three-dimensional images converted from two-dimensional images of claim 23, wherein manipulating the boundary includes incrementally increasing or decreasing a dimension of the source area.

29. The method for providing artifact free three-dimensional images converted from two-dimensional images of claim 23, wherein manipulating the boundary includes variably increasing or decreasing a dimension of the source area.

30. The method for providing artifact free three-dimensional images converted from two-dimensional images of claim 23, wherein using the image content includes expanding the image content to fill the hidden surface area.

31. The method for providing artifact free three-dimensional images converted from two-dimensional images of claim 23, wherein using the image content includes scaling the image content to the hidden surface area.

32. The method for providing artifact free three-dimensional images converted from two-dimensional images of claim 23, wherein using the image content includes fitting the image content to the hidden surface area.

33. A method for providing artifact free three-dimensional images converted from two-dimensional images, comprising:
for a hidden surface area in an image that is part of a three-dimensional image, designating a source area adjacent the reconstruction area by proportionally expanding a boundary portion of the hidden surface area; and
using image content associated with the source area to reconstruct the hidden surface area.

34. The method for providing artifact free three-dimensional images converted from two-dimensional images of claim 33, further including:
manipulating a boundary of the source area to change the image content.

35. The method for providing artifact free three-dimensional images converted from two-dimensional images of claim 34, wherein manipulating the boundary includes repositioning the source area.

36. The method for providing artifact free three-dimensional images converted from two-dimensional images of claim 34, wherein manipulating the boundary includes resizing the source area.

37. The method for providing artifact free three-dimensional images converted from two-dimensional images of claim 34, wherein manipulating the boundary includes reshaping the source area.

38. A method for providing artifact free three-dimensional images converted from two-dimensional images, comprising:
assembling portions of image information from one or more frames into one or more reconstruction work frames; and
using the assembled portions of image information from the work frames to reconstruct an image area of one or more images that are part of a sequence of three-dimensional images.

39. The method for providing artifact free three-dimensional images converted from two-dimensional images of claim 38, wherein the image information is taken from an image content source other than an image that is being reconstructed.

40. The method for providing artifact free three-dimensional images converted from two-dimensional images of claim 38, wherein the image information is taken from multiple image content sources.

41. The method for providing artifact free three-dimensional images converted from two-dimensional images of claim 38, wherein the image information is taken from a single image.

42. The method for providing artifact free three-dimensional images converted from two-dimensional images of claim 38, wherein the image information is taken from multiple images.

43. The method for providing artifact free three-dimensional images converted from two-dimensional images of claim 38, wherein the image information is taken from a sequence of images.

44. A system for providing artifact free three-dimensional images converted from two-dimensional images, comprising:
an interactive user interface configured to allow a user to
assemble portions of image information from one or more frames into one or more reconstruction work frames, and
use the assembled portions of image information from the work frames to reconstruct an image area of one or more images that are part of a sequence of three-dimensional images.

45. A method for providing artifact free three-dimensional images converted from two-dimensional images, comprising:
identifying multiple images in a sequence of three-dimensional images;
processing the multiple images to determine changes in a boundary of an image object that is common to at least two of the images; and
analyzing the changes in the boundary to determine a maximum hidden surface area associated with changes to the image object as the boundaries of the image object change across a sequence of frames representing motion and time.

46. A method for providing artifact free three-dimensional images converted from two-dimensional images, comprising:
identifying a hidden surface area in an image that is part of a three-dimensional image;
identifying a source area of the image that is adjacent the hidden surface area; and
reconstructing the hidden surface area with a mirrored version of image content from the source area.

47. The method for providing artifact free three-dimensional images converted from two-dimensional images of claim 46, wherein reconstructing the hidden surface area includes flipping the image content of the source area along a boundary between the hidden surface area and the source area.

48. The method for providing artifact free three-dimensional images converted from two-dimensional images of claim 46, wherein reconstructing the hidden surface area includes repositioning the mirrored version of image content in relation to the hidden surface area.

49. The method for providing artifact free three-dimensional images converted from two-dimensional images of claim 46, wherein reconstructing the hidden surface area includes fitting the mirrored version of image content within the hidden surface area.

50. The method for providing artifact free three-dimensional images converted from two-dimensional images of claim 49, wherein fitting includes employing an alpha blending or mixing process.

51. A method for providing artifact free three-dimensional images converted from two-dimensional images, comprising:
tracking hidden surface areas in a motion picture sequence of frames in order to reconstruct the hidden surface areas in the frames with image information consistent with surroundings of the hidden surface areas; and
receiving and accessing data in order to present the frames as three-dimensional images whereby a viewer perceives depth.

52. A method for providing artifact free three-dimensional images converted from two-dimensional images, comprising:
tracking hidden surface areas in a motion picture sequence of frames in order to reconstruct the hidden surface areas in the frames with image information consistent with surroundings of the hidden surface areas; and
reproducing the frames as three-dimensional images whereby a viewer perceives depth.

53. A method for providing artifact free three-dimensional images converted from two-dimensional images, comprising:
assembling portions of image information from one or more frames into one or more reconstruction work frames;
using the assembled portions of image information from the work frames to reconstruct an image area to one or more images that are part of a sequence of three-dimensional images;
receiving and accessing the image data; and
reproducing the images as three-dimensional images whereby a viewer perceives depth.

54. An article of data storage media upon which is stored images, information or data created employing any of the methods or systems of claims 1-53.

55. A method for providing a three-dimensional image, comprising:
receiving or accessing data created employing any of the methods or systems of claims 1-53; and
employing the data to reproduce a three-dimensional image.
